(19) United States
(12) Patent Application Publication
(10) Pub. No.: US 2004/0192246 A1
(43) Pub. Date: Sep. 30, 2004

(54) Wireless receiver and transmission system

(76) Inventor: Tain-Der Yeh, Miaoli County (TW)

Correspondence Address: BIRCH STEWART KOLASCH & BIRCH, PO BOX 747, FALLS CHURCH, VA, 22040-0747, US

(21) Appl. No.: 10/788,330

(22) Filed: Mar. 1, 2004

(30) Foreign Application Priority Data
Mar. 26, 2003 (TW) 092106753

(51) Int. Cl. H04B 1/38; H04L 5/16; H04B 1/16

(52) U.S. Cl. 455/339; 455/334; 455/341

(57) ABSTRACT

A wireless receiver for receiving a specific wireless signal. The wireless receiver comprises an antenna, a bandpass filter, a offset device, and a control device. The antenna receives a first wireless signal. The bandpass filter has a resonance frequency, for retrieving the specific wireless signal from the first wireless signal. The specific wireless signal cannot be retrieved if the resonance frequency deviates. The offset device is coupled to the bandpass filter, for offsetting a deviation of the resonance frequency. The control device drives the offset device when the specific wireless signal is not detected by the bandpass filter. A transmission system utilizing the wireless receiver is also disclosed.

### BACKGROUND OF THE INVENTION

1. Field of the Invention

The present invention relates to a wireless transmission system, and more particularly to a wireless transmission system capable of offsetting a deviation of a resonance frequency, and a wireless receiver utilizing the system.

2. Description of the Related Art

During wireless signal transmission, it is necessary to retrieve signals having a fixed frequency. Practically, there may be a variety of signals or noises with different frequencies transmitted wirelessly. The best way to distinguish desired signals from others is by means of a filter.

A filter can discard unwanted signals and admit desired signals pass. By increasing signal to noise ratio, a wireless receiver can achieve high receiving sensitivity. Overcoming deviation in filter components has become an important issue to obtain stable filter performance in varied environments and during manufacture.

A crystal filter has high stability but is very costly. Therefore, a simpler inductor capacitor filter is commonly used.

It is difficult to control values for inductors and capacitors during manufacture resulting in common result values deviating between 5% and 20%. Such deviation can be caused by deviation in a component, such that a wireless receiver may not be able to accurately receive RF signals emitted by a wireless transmitter.

### SUMMARY OF THE INVENTION

It is therefore a first object of the present invention to provide a wireless receiver for offsetting deviation of a resonance frequency, whereby the wireless receiver can receive a specific wireless signal.

It is another object of the present invention to provide a wireless transmission system offsetting a deviation of a resonance frequency to increase product lifetime.

According to the above mentioned objects, the present invention provides a wireless receiver comprising an antenna, a bandpass filter, an offset device, and a control device. The antenna receives a first wireless signal. The bandpass filter has a resonance frequency, for retrieving a specific wireless signal from the first wireless signal. The specific wireless signal cannot be retrieved if the resonance frequency deviates. The offset device is coupled to the bandpass filter, for offsetting a deviation of the resonance frequency. The control device drives the offset device when the specific wireless signal is not detected by the bandpass filter.

The bandpass filter comprises an inductor and a capacitor connected in parallel. The offset device comprises a capacitor group, connected with the capacitor of the bandpass filter in parallel, for providing variable capacitance.

Accordingly, the present invention also provides a wireless transmission system comprising a wireless transmitter and a wireless receiver. The wireless transmitter emits a specific wireless signal. The wireless receiver, for receiving the specific wireless signal, comprises an antenna, a bandpass filter, an offset device, and a control device. The antenna receives the first wireless signal. The bandpass filter has a resonance frequency, for retrieving the specific wireless signal from the first wireless signal. The specific wireless signal cannot be retrieved if the resonance frequency deviates. The offset device is coupled to the bandpass filter, for offsetting a deviation of the resonance frequency. The control device drives the offset device when the specific wireless signal is not detected by the bandpass filter.

### BRIEF DESCRIPTION OF THE DRAWINGS

The present invention can be more fully understood by reading the subsequent detailed description and examples with reference made to the accompanying drawings, wherein:

FIG. 1 is a block diagram of a wireless transmission system of the present invention;

FIG. 2 is a block diagram of the wireless receiver of the present invention;

FIG. 3 shows a circuit of the offset device;

FIG. 4 is a block diagram of the conversion device;

FIG. 5 shows a first embodiment of the wireless receiver of the present invention.

### DETAILED DESCRIPTION OF THE INVENTION

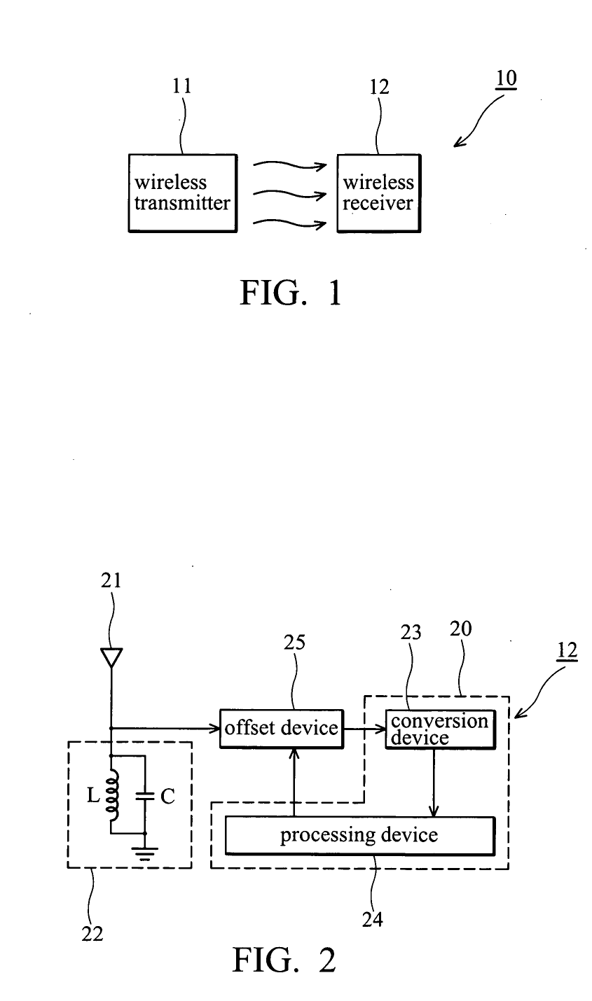

FIG. 1 is a block diagram of a wireless transmission system of the present invention. The wireless transmission system 10 comprises a wireless transmitter 11 and a wireless receiver 12. The wireless transmitter 11 emits a specific wireless signal. The wireless receiver 12 receives the specific wireless signal from the wireless transmitter 11.

FIG. 2 is a block diagram of the wireless receiver of the present invention. The wireless receiver 12 comprises an antenna 21, a bandpass filter 22, an offset device 25, and a control device 20. The antenna 21 receives a first wireless signal. The bandpass filter 22 has a resonance frequency, for retrieving the specific wireless signal from the first wireless signal. The specific wireless signal cannot be retrieved if the resonance frequency deviates. The offset device 25 is coupled to the bandpass filter 22, for offsetting a deviation of the resonance frequency. The control device 20 drives the offset device 25 when the specific wireless signal is not detected by the bandpass filter 22.

The control device 20 comprises a conversion device 23 and a processing device 24. The conversion device 23 convents the specific retrieved wireless signal into a digital value. The processing device 24 receives the digital value and detects whether the resonance frequency deviates.

The bandpass filter 22 comprises an inductor L and a capacitor C connected in parallel. The resonance frequency f is obtained by:

$$f = \frac{1}{2 π \sqrt{LC}} ;$$

Wherein f is the resonance frequency, L is the inductance of the inductor L, and C is the first capacitance of the capacitor C.

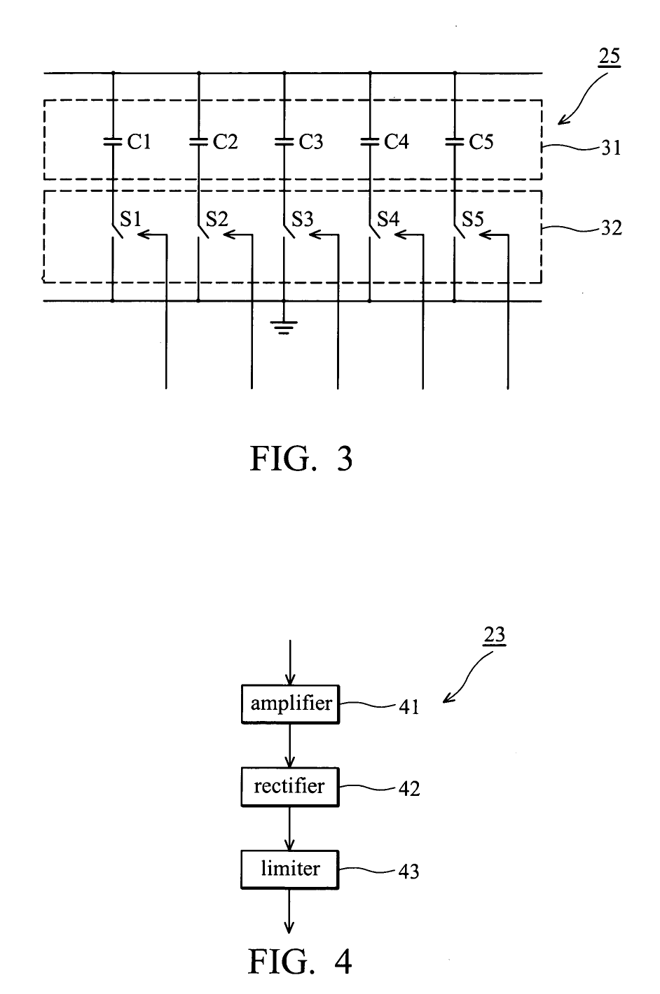

FIG. 3 shows a circuit of the offset device. The offset device 25 comprises a capacitor group 31, connected with the capacitor C of the bandpass filter 22 in parallel, providing a variably capacitance.

The capacitor group 31 comprises capacitors connected with one another in parallel. The accuracy of offset device 25 increases with the number of capacitors. In the present invention, the capacitor group 31 has five capacitors C1˜C5.

Capacitances of capacitors C1˜C5 are different; forming a geometric sequence (such as C1=2⁰C1, C2=2¹C1, C3=2²C1, C4=2³C1, C5=2⁴C1). Each of the capacitors C1˜C5 is connected in series with a corresponding switch device S1˜S5. The control device 20 turns the switch devices S1˜S5 on or off.

FIG. 4 is a block diagram of the conversion device. The conversion device 23 comprises an amplifier 41, a rectifier 42, and a limiter 43. The amplifier 41 amplifies the specific wireless signal received. The rectifier 42 transforms the amplified specific wireless signal into a voltage signal. The limiter normalizes the voltage signal with the digital value.

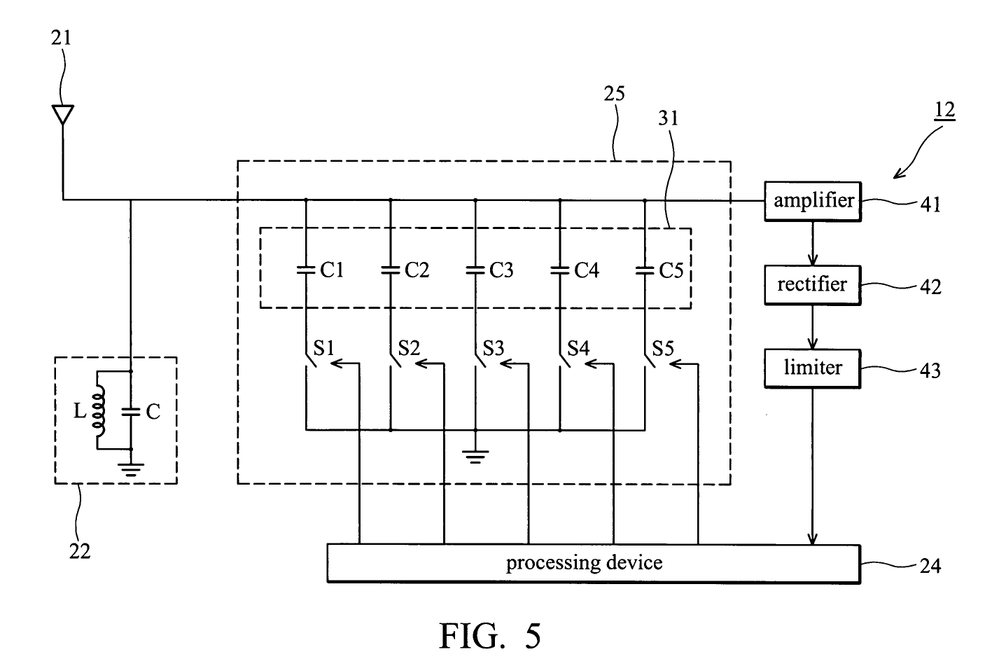

FIG. 5 shows a first embodiment of the wireless receiver of the present invention. The wireless transmitter (not shown) emits a first wireless signal comprising a specific wireless signal, received by an antenna 21. If the specific wireless signal is 27 MHz, the resonance frequency generated by the bandpass filter 22 is also 27 MHz. Therefore, the wireless receiver can receive the specific wireless signal from the first wireless signal. When inductance of the inductor L is 1.8 μH and capacitance of the capacitor C 20 pF, the bandpass filter 22 generates the resonance frequency of 27 MHz. The inductance of the inductor L has an error value between +10% and −10%, as does capacitance of the capacitor C, such that the bandpass filter 22 has error value between +20% and −20%. The capacitance sum of capacitors C1˜C5 must offset the error value of the bandpass filter 22.

If the error value is −10%, the inductance of the inductor L is changed from 1.8 pH to 1.6 pH. If the error value is −10%, the capacitance of the capacitor C is changed from 20 pF to 18 pF. Therefore, the resonance frequency is 29.47 MHz. The resonance frequency increases as inductance and capacitance decrease. The capacitors C1˜C5 and the capacitor C of the bandpass filter 22 are connected in parallel, to increase capacitance of the capacitor C of the bandpass filter 22. Therefore, the resonance frequency decreases.

The processing device 24 turns the switch devices S1˜S5 on or off to adjust the resonance frequency. The switch device S1 turns on and switch devices S2˜S5 turn off as the processing device 24 outputs a signal of 00001. The bandpass filter 22 has the capacitance sum of the capacitors C1 and C. The switch device S2 turns on and switch devices S1, S3˜S5 turn off as the processing device 24 outputs a signal of 00010. The bandpass filter 22 has the capacitance sum of the capacitors C2 and C. Therefore, the capacitance sum of the bandpass filter 2 is changed as the processing device 24 outputs a different signal.

Because the capacitors C1˜C5 have different capacitances, the capacitance of the capacitor group 31 changes with the capacitance sum of the bandpass filter 22. The processing device 24 can output five bits of data, so the bandpass filter 22 generates thirty-two resonance frequencies.

The following table shows the relations hip between the resonance frequency and the group of capacitor 31:

TABLE 1

| | capacitance of | |
|---|---|---|
| bandpass | the group of | resonance |
| filter 22 | capacitor 31 | frequency |
| inductance = 1.6 μH | 0 | 29.47 MHz |
| and capacitance = 18 pF | | |
| inductance = 1.6 μH | 2 pF | 27.96 MHz |
| and capacitance = 18 pF | | |
| inductance = 1.6 μH | 4 pF | 26.6 MHz |
| and capacitance = 18 pF | | |

The processing device 24 changes the state of the switches S1˜S5 to adjust the resonance frequency when the processing device 24 does not receive a specific wireless signal emitted by the wireless transmitter.

When the processing device 24 adjusts the resonance frequency, the wireless receiver cannot receive any frequency. Adjustment time is less than 100 ms, unnoticeable to users.

The present invention can be applied to any wireless transmission system. The antenna of the wireless receiver can be affected by temperature, material, shape, or other factor. Utilizing the present invention during manufacture, the products are enabled for auto-adjustment of the resonance frequency, solving the deviation thereof.

The present invention offsets deviation of resonance frequency to improve transmission, compensating for environmental change, thereby increasing product lifetime.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A wireless receiver, comprising:
an antenna for receiving a first wireless signal;
a bandpass filter, having a resonance frequency, for retrieving A specific wireless signal from the first wireless signal, wherein the specific wireless signal cannot be retrieved if the resonance frequency deviates from a standard frequency;
an offset device, coupled to the bandpass filter, for offsetting a deviation of the resonance frequency; and
a control device for driving the offset device when the specific wireless signal is not detected by the bandpass filter.

2. The wireless receiver as claimed in claim 1, wherein the bandpass filter comprises an inductor and a capacitor connected in parallel.

3. The wireless receiver as claimed in claim 2, wherein the offset device comprises a capacitor group, connected with the capacitor of the bandpass filter in parallel, for providing variable capacitance.

4. The wireless receiver as claimed in claim 3, wherein the capacitor group comprises a plurality of capacitors connected in parallel.

5. The wireless receiver as claimed in claim 4, wherein the offset device further comprises a plurality of switches, connected with the corresponding capacitors in series, each of which is turned on or off by the control device.

6. The wireless receiver as claimed in claim 5, wherein capacitances of the capacitors within the capacitor group form a geometric sequence.

7. The wireless receiver as claimed in claim 6, wherein a maximum negative inductance deviation of the inductor is taken as the inductance of the inductor, and a maximum negative capacitance deviation of the capacitor is taken as the capacitance of the capacitor.

8. The wireless receiver as claimed in claim 7, wherein the control device comprises:
a conversion device for controlling the retrieved specific wireless signal into a digital value; and
a processing device for receiving the digital value and detecting whether the resonance frequency deviates from the standard frequency.

9. The wireless receiver as claimed in claim 8, wherein the conversion device comprises:
an amplifier for amplifying the specific wireless signal received;
a rectifier for transforming the amplified specific wireless signal into a voltage signal; and
a limiter for normalizing the voltage signal with the digital value.

10. A wireless transmission system, comprising:
a wireless transmitter for emitting a specific wireless signal; and
a wireless receiver for receiving the specific wireless signal, comprising:
an antenna for receiving a first wireless signal;
a bandpass filter, having a resonance frequency, for retrieving the specific wireless signal from the first wireless signal, wherein the specific wireless signal cannot be retrieved if the resonance frequency deviates from a standard frequency;
an offset device, coupled to the bandpass filter, for offsetting a deviation of the resonance frequency; and
a control device for driving the offset device when the specific wireless signal is not detected by the bandpass filter.

11. The system as claimed in claim 10, wherein the bandpass filter comprises an inductor and a capacitor connected in parallel.

12. The system as claimed in claim 11, wherein the offset device comprises a capacitor group, connected with the capacitor of the bandpass filter in parallel, for providing variable capacitance.

13. The system as claimed in claim 12, wherein the capacitor group comprises a plurality of capacitors connected in parallel.

14. The system as claimed in claim 13, wherein the offset device further comprises a plurality of switches, connected with the corresponding capacitors in series style, each of which is turned on or off by the control device.

15. The system as claimed in claim 14, wherein capacitances of the capacitors within the capacitor group form a geometric sequence.

16. The system as claimed in claim 15, wherein a maximum negative inductance deviation of the inductor is taken as the inductance of the inductor, and a maximum negative capacitance deviation of the capacitor is taken as the capacitance of the capacitor.

17. The system as claimed in claim 16, wherein the control device comprises:
a conversion device for controlling the retrieved specific wireless signal into a digital value; and
a processing device for receiving the digital value and detecting whether the resonance frequency deviates.

18. The system as claimed in claim 17, wherein the conversion device comprises:
an amplifier for amplifying the specific wireless signal received;
a rectifier for transforming the amplified specific wireless signal into a voltage signal; and
a limiter for normalizing the voltage signal with the digital value.
